(19) United States
(12) Patent Application Publication
(10) Pub. No.: US 2026/0347531 A1
(43) Pub. Date: Nov. 5, 2026

(54) POLYETHER POLYOL, ITS PRODUCTION METHOD AND ITS USE, AND FLEXIBLE POLYURETHANE FOAM

(71) Applicant: PCC ROKITA SPOLKA AKCYJNA, Brzeg Dolny (PL)

(72) Inventors: Miroslaw PLOCIENIAK, Wroclaw (PL); Michal SALASA, Brzeg Dolny (PL); Lukasz MAKULA, Wroclaw (PL); Magdalena WROBLEWSKA, Wroclaw (PL); Henryk WOJDYLA, Wolow (PL)

(21) Appl. No.: 19/114,265

(22) PCT Filed: Sep. 25, 2023
(86) PCT No.: PCT/PL2023/050079

§ 371 Date: Mar. 21, 2025

(30) Foreign Application Priority Data
Sep. 26, 2022 (PL) P.442356

(51) Int. Cl. C08G 18/48; C08G 65/26

(52) U.S. Cl. CPC C08G 18/4841; C08G 18/4854; C08G 18/4858; C08G 65/2609; C08G 65/2615; C08G 65/2663; C08G 2110/0008; C08G 2110/0083

(57) ABSTRACT

An object of the invention is a polyether polyol containing 75 to 100 mole % of primary hydroxyl groups and having a hydrocarbon coefficient (ww) of at least 8.5, the hydrocarbon coefficient being calculated according to the formula: where: a is the number of carbon atoms in the polyether polyol molecule, which is the sum of the numbers of carbon atoms originating from the starter, ethylene oxide and C3-C8 epoxide used to produce the said polyol; b is the number of hydrogen atoms in the polyether polyol molecule, which is the sum of the numbers of hydrogen atoms originating from the starter, ethylene oxide and C3-C8 epoxide used to produce the said polyol; d is the number of oxygen atoms in the polyether polyol molecule, which is the sum of the numbers of oxygen atoms originating from the starter, ethylene oxide and C3-C8 epoxide used to produce the said polyol. Another object of the invention is a method of producing a polyether polyol with the above-entioned properties and its use in the production of flexible polyurethane foams. Furthermore, an object of the invention is also a flexible polyurethane foam produced with the use of the polyol described above.

$${w}_{W} = \frac{4 a + b}{2 d}$$

An object of the invention is a polyether polyol, its production method and its use for producing flexible polyurethane foams. Another object of the invention is a flexible polyurethane foam produced with the use of the polyether polyol according to the invention.

Polyether polyols are of great interest to the polyurethane industry, as they are the main ingredient in the production of polyurethane foams. Polyether polyols are a special case of alkylene oxide oligomers with molecular weights mostly in the range of 500 to 6000, often with a high content of primary hydroxyl groups. Polyether polyols are the products of oxyalkylation reactions, i.e. the addition of alkylene oxides to various compounds containing an active hydrogen atom, such as mono- and polyfunctional alcohols, amines, or thiols.

An important parameter for determining the applicability of polyether polyols in the production of polyurethane foams is the hydrocarbon coefficient, which provides a simple way to determine the hydrophilicity or, more broadly, the hydrophilic-hydrophobic balance of a given polyether polyol. The higher the value of the coefficient, the lower the hydrophilicity of the polyol. A sufficiently low hydrophilicity of the polyol used is required to achieve appropriate foam parameters. The hydrocarbon coefficient is the inverse of the oxygen coefficient, which is a term mainly used in pyrotechnics. The oxygen coefficient, a derivative of the oxygen balance, is defined as the ratio of the amount of oxygen in the material to the amount of oxygen required to fully oxidise the combustible elements, i.e. carbon to CO₂ and hydrogen to H₂O (in the case of a material that has a composition of CₐH_{b}N_{c}O_{d}). It is calculated according to the formula:

$${w}_{T} = \frac{d}{2 a + \frac{b}{2}}$$

After transforming this formula, the hydrocarbon coefficient is obtained, expressed by the formula below.

$${w}_{W} = \frac{4 a + b}{2 d}$$

where:
a is the number of carbon atoms in the polyether polyol molecule, which is the sum of the numbers of carbon atoms originating from the starter, ethylene oxide and epoxide used to produce the said polyol;
b is the number of hydrogen atoms in the polyether polyol molecule, which is the sum of the numbers of hydrogen atoms originating from the starter, ethylene oxide and epoxide used to produce the said polyol;
d is the number of oxygen atoms in the polyether polyol molecule, which is the sum of the numbers of oxygen atoms originating from the starter, ethylene oxide and epoxide used to produce the said polyol.

When calculating the hydrocarbon coefficient, it is important to pay attention to the presence of at least one oxygen atom in the molecule relative to which the calculations are made. The absence of an oxygen atom makes the calculation of the hydrocarbon coefficient impossible due to the presence of a zero value in the denominator of the fraction, it being obvious to one skilled in the art that a molecule lacking an oxygen atom can be neither a starter nor an epoxide in the terms of this invention.

The following describes the method of calculating the hydrocarbon coefficient for a polyether polyol produced using any starter and a mixture of ethylene oxide and propylene oxide, and therefore for a polyol containing oxyethylene and oxypropylene groups combined with a starter.

First, it is necessary to calculate the sums of the numbers of carbon (a), hydrogen (b) and oxygen (d) atoms originating from the starter, ethylene oxide (TE) and propylene oxide (TP), a=Σ(aₛₜₐᵣₜₑᵣ, a_{TP}, a_{TE}), b=Σ(bₛₜₐᵣₜₑᵣ, b_{TP}, b_{TE}), d=Σ(dₛₜₐᵣₜₑᵣ, d_{TP}, d_{TE}), respectively, and substitute them into the formula above determining the hydrocarbon coefficient (w_{w}). Due to the statistical, dispersive structure of oligomers, it is acceptable for the above atomic numbers to be rational numbers instead of natural numbers.

In the case of a polyol produced using a mixture of ethylene oxide and any other epoxide, instead of the numbers of individual atoms originating from the propylene oxide, the corresponding numbers of atoms originating from the epoxide used are calculated. If a mixture of epoxides is used, weighted averages are calculated.

In order to calculate the hydrocarbon coefficient, it is sufficient to know the basic characteristics of the polyether polyol and the starter, such as:
Hydroxyl value OHV [mg KOH/g] of polyol;
Chemical structure of the starter: the chemical formula from which the values aₛₜₐᵣₜₑᵣ, bₛₜₐᵣₜₑᵣ, dₛₜₐᵣₜₑᵣ can be obtained, its molecular weight MWₛₜₐᵣₜₑᵣ [g/mol] and its functionality f (natural number corresponding to the number of hydroxyl groups in one starter molecule) [dimensionless];
Total content of oxyethylene groups (% TE) in polyol [% by weight].

Based on the hydroxyl value of the polyol and the functionality of the starter, the molecular weight of the polyol is determined:

$${MW}_{polyol} = \frac{f \cdot 56110}{OHV}$$

where the value 56110 is a constant equal to the molecular weight of KOH (56.11) multiplied by 1000.

Using the known molecular weight of the starter (MWₛₜₐᵣₜₑᵣ), the weight proportion of the starter in the polyol molecule is calculated:

$${\%}_{starter} = \frac{{MW}_{starter}}{{MW}_{polyol}} \cdot 100$$

Then, using the calculated or determined % TE value and the calculated % starter value, the weight proportion of propylene oxide in the polyol molecule is calculated:

%_{TP}=100−%_{TE}−%ₛₜₐᵣₜₑᵣ

In the next step, the partial molecular weights in the polyol molecule of propylene oxide (% MW_{TP}) and ethylene oxide (% MW_{TE}) are calculated:

$$\begin{matrix}\% {MW}_{TP} = \frac{{\%}_{TP}}{100} \cdot {MW}_{polyol} \\ \% {MW}_{TE} = \frac{{\%}_{TE}}{100} \cdot {MW}_{polyol}\end{matrix}$$

Then, based on the calculated partial molecular weights, on the known numbers of carbon, oxygen and hydrogen atoms in the ethylene oxide and propylene oxide molecule and on the molecular weights of these compounds, the numbers of carbon, hydrogen and oxygen atoms in the polyol molecule, originating from these compounds are calculated using the formulas below:

$$\begin{matrix}{a}_{TE} = \frac{\% {MW}_{TE}}{44 , 05} \cdot 2 \\ {b}_{TE} = \frac{\% {MW}_{TE}}{44 , 05} \cdot 4 \\ {d}_{TE} = \frac{\% {MW}_{TE}}{44 , 05} \cdot 1 \\ {a}_{TP} = \frac{\% {MW}_{TP}}{58 , 08} \cdot 3 \\ {b}_{TP} = \frac{\% {MW}_{TP}}{58 , 08} \cdot 6 \\ {d}_{TP} = \frac{\% {MW}_{TP}}{58 , 08} \cdot 1\end{matrix}$$

where
a_{TE} and a_{TP} are the numbers of carbon atoms in the polyol molecule, originating from ethylene oxide and propylene oxide, respectively;
b_{TE} and b_{TP} are the numbers of hydrogen atoms in the polyol molecule, originating from ethylene oxide and propylene oxide, respectively;
d_{TE} and d_{TP} are the numbers of oxygen atoms in the polyol molecule, originating from ethylene oxide and propylene oxide, respectively;
2 and 3 are the numbers of carbon atoms in the molecule of ethylene oxide and propylene oxide, respectively,
4 and 6 are the numbers of hydrogen atoms in the molecule of ethylene oxide and propylene oxide, respectively,
1 is the number of oxygen atoms, which is the same in the molecule of ethylene oxide and propylene oxide,
% MW_{TE} and % MW_{TP} are the partial molecular weights in the polyol molecule of ethylene oxide and propylene oxide, respectively,
44.05 and 58.08 are the molecular weights of ethylene oxide and propylene oxide, respectively.

The aₛₜₐᵣₜₑᵣ, bₛₜₐᵣₜₑᵣ and dₛₜₐᵣₜₑᵣ values representing the numbers of carbon, hydrogen and oxygen atoms, respectively, in the polyol molecule, originating from the starter, can be obtained from the starter's molecular formula, generally written as: CₐH_{b}O_{d}.

In the final step, the hydrocarbon coefficient of the polyol is calculated based on the general formula given above and on the calculated numbers of carbon, hydrogen and oxygen atoms originating from the individual components of the polyol:

$${w}_{W} = \frac{4 \cdot \sum ( {a}_{starter} , {a}_{TP} , {a}_{TE} ) + \sum ( {b}_{starter} , {b}_{TP} , {b}_{TE} )}{2 \cdot \sum ( {d}_{starter} , {d}_{TP} , {d}_{TE} )}$$

From the point of view of the use in the production of flexible polyurethane foams, an important parameter of the polyol is also the content of primary hydroxyl groups in the polyol molecule. The amount of primary hydroxyl groups is usually presented as a molar percentage relative to all hydroxyl groups present in the molecule. Primary hydroxyl groups are particularly desirable due to their higher reactivity towards isocyanates, compared to secondary and tertiary hydroxyl groups. A primary hydroxyl group is defined as a hydroxyl group covalently bonded to a CH₂ group. In polyols, primary hydroxyl groups are primarily originating from terminal oxyethylene groups, which can be represented by the general formula R—CH₂—CH₂—OH.

Another parameter used to characterise polyols is the functionality, which determines the number of hydroxyl groups per oligomer molecule and is a weighted average of the functionality of all components of the polyol. By definition, it should be larger than or equal to 2.

The classic method of obtaining polyether polyols with a high content of primary hydroxyl groups is the use of ethylene oxide, leading to the formation of oxyethylene groups in the polyols. It is possible to use a block or block-static polymer topology, using an anionic catalyst, preferably potassium hydroxide (KOH). This process is generally known, described in the literature and used in industry since the 1950s. In the first step of the process, propylene oxide or a mixture of ethylene oxide and propylene oxide is dosed into the mixture containing the starter and the KOH catalyst, while in the final step only ethylene oxide is dosed. The final step is often called capping because the polymer chain is being capped with oxyethylene groups. The capping of the chain with oxyethylene groups is important from the point of view of the use of polyether polyols, in particular for the production of flexible foams, due to the fact that primary hydroxyl groups, including those originating from terminal oxyethylene groups, are much more reactive towards isocyanates used alongside polyols during foam production than secondary hydroxyl groups. However, during the production of polyether polyols in the presence of a KOH catalyst, as a result of side reactions low-molecular-weight compounds containing double bonds, generally classified as unsaturation are formed. These compounds have an adverse effect on the odour properties of polyether polyols, as well as on the odour properties of foams produced from these polyols. Furthermore, the process that uses KOH as a catalyst requires a subsequent purification step involving acidification, drying and filtration. These steps are time-consuming, energy-intensive and require additional equipment. Therefore, solutions are being sought to eliminate the above-mentioned problems.

Another, more modern method of obtaining polyether polyols is a process carried out using a double metal cyanide (DMC) catalyst. The method has been known since the 1960s, but was not initially commercialised. Thanks to the intensive development of DMC catalysts, initiated in the 1990s, it was possible to obtain much more active catalysts and thus to reduce the concentrations used, making the purification process required for the KOH catalyst unnecessary. Neither is it necessary to remove small amounts of the DMC catalyst used. Thanks to its high catalytic activity, the oxyalkylation reaction proceeds faster than with the KOH catalyst, and the concentration of free oxides in the reaction mass can be kept at a lower level, so that the pressure in the reactor is lower and the whole process on a technical scale is safer. In addition to not requiring purification, an additional advantage of using DMC catalysts is the lower proportion of side reactions and, consequently, significantly lower levels of unsaturation in the resulting products. Documents U.S. Pat. Nos. 5,158,922, 5,714,639, PL 187097, U.S. Pat. No. 5,627,120 disclose methods of obtaining and using double metal cyanide (DMC) catalysts for the preparation of polyether polyols. However, despite the above-mentioned advantages, the method that uses a DMC catalyst has certain limitations. Due to the use of low concentrations of the DMC catalyst, there is an increased risk of this catalyst being poisoned in the reaction system by, for example, alkali metal ions. Unlike anionic catalysts, it is not possible to directly terminate the chain with oxyethylene groups. Dosing ethylene oxide into a reaction system containing a polyether polyol rich in oxypropylene groups results in a two-phase system containing the original polyol and poly(ethylene oxide). The attachment of oxyethylene groups to the primary polyol occurs to only a minimal extent. Therefore, a thesis generally accepted in the industry is that it is not possible to produce polyether polyols terminated with ethylene oxide using a DMC catalyst. Researchers from different countries have therefore tried to find a solution to this problem. However, it has become apparent that solving one problem can create another, in particular, an increase in the proportion of oxyethylene groups in the polyol molecule results in a reduction in the hydrocarbon coefficient and associated excessive hydrophilicity of the polyol, through which a deterioration in the performance of the flexible foam produced using it is observed.

Documents U.S. Pat. Nos. 4,721,818 and 5,563,221 disclose ethylene oxide termination of a polyether polyol prepared with a DMC catalyst rich in propylene oxide using anionic catalysis. However, the described method entails a time- and energy-consuming step to purify the polyols thus produced. Another disadvantage of this method is the need to use two different catalysts, which adversely affects its economic aspect. Therefore, this method would be problematic to apply in production practice.

Document PL 199 860 (U.S. Pat. No. 6,617,419 B1) discloses a method of producing polyether polyols using a DMC catalyst in which the proportion of primary hydroxyl groups is between 40 and 95% and the total proportion of oxyethylene groups is above 25% by weight. In addition, the products described in the examples are characterised by hydrocarbon coefficients ranging from 6.4 to 7.4.

Document U.S. Pat. No. 10,301,419 B2 discloses a method of producing polyether polyols (copolymers of ethylene oxide and propylene oxide) that uses a variable concentration of ethylene oxide in the dosed mixture, with an initial concentration of ethylene oxide ranging from 1 to 5% and a final concentration ranging from 90 to 100%. The disadvantage of polyether polyols produced by this method is that the content of primary hydroxyl groups is too low (examples in the range of 40-51%), making their use in the production of flexible foams limited. In addition, the products described in the examples are characterised by hydrocarbon coefficients ranging from 8.1 to 8.2.

Document U.S. Pat. No. 6,884,826 B2 discloses a method of producing polyoxyalkylene polyols, in which a variable concentration of ethylene oxide is used in the dosed mixture, with propylene oxide alone being dosed initially, after a gradual increase in the proportion of ethylene oxide, the product being degassed and then ethylene oxide alone being dosed. The polyols described in the examples are characterised by a content of primary hydroxyl groups ranging from 39 to 75% and a hydrocarbon coefficient ranging from 8.1 to 8.5. A proportion of primary hydroxyl groups below about 75% results in too low reactivity of the polyol in the production processes of flexible foams, so that the foaming profile deteriorates.

A comparison of the hydrocarbon coefficients (w_{w}) and the contents of primary hydroxyl groups in the polyether polyols disclosed in the above-mentioned documents is shown below.

| | | | % by | | |
|---|---|---|---|---|---|
| | | | weight of | | % content |
| | | | ethylene | | of I OH |
| Polyol | Starter | OHV | oxide | w_{w} | groups |
| Example 1 of | Glycerine | 59.1 | 59.8 | 6.8 | 56 |
| PL 199 860 B1 | | | | | |
| Example 2 of | Glycerine | 58.5 | 76.4 | 6.4 | 81 |
| PL 199 860 B1 | | | | | |
| Example 3 of | Glycerine | 53.9 | 38.8 | 7.4 | 52 |
| PL 199 860 B1 | | | | | |
| Example 4 of | Glycerine | 54.0 | 54.3 | 6.9 | 67 |
| PL 199 860 B1 | | | | | |
| Example 1 of | Glycerine | 34.5 | 17.6 | 8.2 | 50.4 |
| U.S. Pat. No. 10,301,419 B1 | | | | | |
| Example 2 of | Glycerine | 34.9 | 17.6 | 8.2 | 42.3 |
| U.S. Pat. No. 10,301,419 B1 | | | | | |
| Comparative | Glycerine | 35.9 | 19.3 | 8.1 | 48.4 |
| polyol A of | | | | | |
| U.S. Pat. No. 10,301,419 B1 | | | | | |
| Examples 3-6 of | Glycerine | 34.1-35.6 | 17.6 | 8.2 | 40.3-42.8 |
| U.S. Pat. No. 10,301,419 B1 | | | | | |
| Comparative | Glycerine | 35.1 | 20.6 | 8.1 | 51.0 |
| polyol B of | | | | | |
| U.S. Pat. No. 10,301,419 B1 | | | | | |
| Example 1 of | Glycerine | 30.0 | 19.5 | 8.1 | 55.6 |
| U.S. Pat. No. 6,884,826 B1 | | | | | |
| Example 2 of | Glycerine | 30.5 | 19.5 | 8.1 | 64.1 |
| U.S. Pat. No. 6,884,826 B1 | | | | | |
| Example 3 of | Propylene | 28.7 | 19.4 | 8.3 | 74.9 |
| U.S. Pat. No. 6,884,826 B1 | glycol (diol) | | | | |
| Example 4 of | (unknown, | 28.2 | 15.6 | approx. | 39.2 |
| U.S. Pat. No. 6,884,826 B1 | triol) | | | 8.4 | |
| Example 5 of | (unknown, | 28.0 | 16.0 | approx. | 50.5 |
| U.S. Pat. No. 6,884,826 B1 | triol) | | | 8.4 | |
| Example 6 of | (unknown, | 28.3 | 13.9 | approx. | 54.5 |
| U.S. Pat. No. 6,884,826 B1 | triol) | | | 8.5 | |
| Example 7 of | (unknown, | 28.4 | 15.9 | approx. | 56.2 |
| U.S. Pat. No. 6,884,826 B1 | triol) | | | 8.4 | |
| Example 8 of | (unknown, | 29.2 | 15.3 | approx. | 56.0 |
| U.S. Pat. No. 6,884,826 B1 | triol) | | | 8.4 | |
| Example 9 of | (unknown, | 28.0 | 15.5 | approx. | 57.2 |
| U.S. Pat. No. 6,884,826 B1 | triol) | | | 8.4 | |
| Example 10 of | (unknown, | 28.6 | 16.1 | approx. | 59.0 |
| U.S. Pat. No. 6,884,826 B1 | triol) | | | 8.4 | |
| Example 11 of | (unknown, | 29.3 | 19.3 | approx. | 68.0 |
| U.S. Pat. No. 6,884,826 B1 | triol) | | | 8.3 | |
| Polyoxy- | Glycerine | 336.5 | 0 | 7.3 | <5 |
| propylene | | | | | |
| glycerine with | | | | | |
| MW of 500 | | | | | |
| Polyoxy- | Glycerine | 33.6 | 0 | 8.8 | <5 |
| propylene | | | | | |
| glycerine with | | | | | |
| MW of 5000 | | | | | |
| Polyoxy-ethylene | Glycerine | 336.5 | 81 | 5.4 | 100 |
| glycerine with | | | | | |
| MW of 500 | | | | | |
| Polyoxy-ethylene | Glycerine | 33.6 | 98 | 5.9 | 100 |
| glycerine with | | | | | |
| MW of 5000 | | | | | |
| Poly(propylene | Propylene | Irrelevant | 0 | 9.0 | <5 |
| oxide) | glycol | | | | |
| Poly(ethylene | Ethylene | Irrelevant | 100 | 6.0 | 100 |
| oxide) | glycol | | | | |

The present inventors have determined that polyols characterised by a high content of primary hydroxyl groups (75-100%) and a high hydrocarbon coefficient (at least 8.5) are particularly suitable for the production of flexible polyurethane foams, especially highly resilient ones. As is evident from the data presented in the table above, no polyether polyols produced using a DMC catalyst, characterised by such properties have yet been reported. The polyols described in the state of the art are characterised by too low hydrocarbon coefficients and therefore excessive hydrophilicity, which would contribute to the deterioration of parameters of foams produced using them. Thus, the suitability of polyols obtained by means of state-of-the-art methods for the production of flexible polyurethane foams, especially highly resilient ones, is limited. Accordingly, the aim of the present invention was to develop a method of producing polyols having the above-mentioned properties while eliminating the disadvantages encountered when using methods known in the state of the art. These disadvantages include the production of unsaturated compounds and the need for purification if a KOH catalyst is used, and the excessive hydrophilicity of polyols due to gradual chain termination with ethylene oxide if a DMC catalyst is used.

An object of the invention is a polyether polyol containing 75 to 100 mole % of primary hydroxyl groups relative to all hydroxyl groups and having a hydrocarbon coefficient (w_{w}) of at least 8.5, the hydrocarbon coefficient being calculated according to the formula:

$${w}_{W} = \frac{4 a + b}{2 d}$$

where:
a is the number of carbon atoms in the polyether polyol molecule, which is the sum of the numbers of carbon atoms originating from the starter, ethylene oxide and C3-C8 epoxide used to produce the said polyol;
b is the number of hydrogen atoms in the polyether polyol molecule, which is the sum of the numbers of hydrogen atoms originating from the starter, ethylene oxide and C3-C8 epoxide used to produce the said polyol;
d is the number of oxygen atoms in the polyether polyol molecule, which is the sum of the numbers of oxygen atoms originating from the starter, ethylene oxide and C3-C8 epoxide used to produce the said polyol.

Preferably, the hydrocarbon coefficient (w_{w}) of the polyether polyol ranges from 8.5 to 10.0.

Preferably, the polyether polyol contains between 75 and 90 mole % of primary hydroxyl groups relative to all hydroxyl groups.

Another object of the invention is a method of producing a polyether polyol containing 75 to 100 mole % of primary hydroxyl groups relative to all hydroxyl groups and having a hydrocarbon coefficient (w_{w}) of at least 8.5, comprising the following steps:
a) preparing a initial charge containing:
   a starter or a mixture of starters containing hydroxyl groups, and
   double metal cyanide (DMC) catalyst;
b) drying the initial charge;
c) dosing C3-C8 epoxide or a mixture of C3-C8 epoxide with ethylene oxide into the initial charge and leaving the mixture until the reaction exotherm takes place in order to activate the DMC catalyst;
d) dosing, to the mixture obtained in step c), a mixture containing ethylene oxide and C3-C8 epoxide or a mixture of C3-C8 epoxides in which the weight proportions of ethylene oxide and C3-C8 epoxide or of the mixture of C3-C8 epoxides are changed in a stepwise or continuous manner in order to oxyalkylate the starter against the activated DMC catalyst, with the initial proportion of ethylene oxide in the dosed mixture ranging from 5 to 15% by weight and the final proportion ranging from 70 to 100% by weight, and the temperature of the resulting mixture being maintained between 100 °C and 150 °C; and
e) annealing the polyether polyol at a temperature ranging from 100 °C to 150 °C until constant pressure is obtained and removing volatile compounds;
wherein the method uses C3-C8 epoxide represented by the general structural formula:

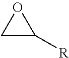

where R is an alkyl group, an aryl group, or a cycloalkyl group, the total number of carbon atoms in these groups being between 1 and 6, so that the molecule of this epoxide contains between 3 and 8 carbon atoms;
wherein the same or different C3-C8 epoxides are used in steps (c) and (d);
wherein the method uses (i) a starter or a mixture of starters with a hydrocarbon coefficient of at least 9.5 or (ii) C3-C8 epoxide or a mixture of C3-C8 epoxides with a hydrocarbon coefficient of at least 9.5 or (iii) a starter or a mixture of starters and C3-C8 epoxide or a mixture of C3-C8 epoxides with hydrocarbon coefficients of at least 9.5;
wherein in the case of using a mixture of starters or C3-C8 epoxides, the weighted average of the hydrocarbon coefficients of the individual components is taken into account;
wherein the hydrocarbon coefficients of the C3-C8 epoxide and the starter, represented by the general formula CₐH_{b}O_{d}, are calculated according to the formula

$${w}_{W} = \frac{4 a + b}{2 d}$$

where:
a is the number of carbon atoms in the molecule of C3-C8 epoxide or starter,
b is the number of hydrogen atoms in the molecule of C3-C8 epoxide or starter,
d is the number of oxygen atoms in the molecule of C3-C8 epoxide or starter.

Preferably, a compound containing on average 2.5 to 8 hydroxyl groups per molecule and with an average equivalent chain weight per hydroxyl group of 170 to 500 is used as the starter, more preferably vegetable oil or modified vegetable oil is used as the starter and most preferably castor oil is used as the starter.

Preferably, in step c), C3-C8 epoxide or a mixture of C3-C8 epoxide with ethylene oxide is used in an amount of 2% to 20% by weight relative to the amount of the preliminary feed, with C3-C8 epoxide or a mixture of C3-C8 epoxide with ethylene oxide being added in one or more portions.

Preferably, in step d), propylene oxide, 1,2-butylene oxide, styrene oxide, 1,2-epoxypentane, 1,2-epoxyhexane, epoxycyclohexane or 1,2-epoxyoctane or a mixture thereof is used as the C3-C8 epoxide or the mixture of C3-C8 epoxides, and more preferably propylene oxide, styrene oxide, 1,2-butylene oxide or a mixture thereof is used.

Preferably, a mixture in which the weight proportion of ethylene oxide is 100% is dosed at the end of step d).

Preferably, using the method according to the invention, a polyether polyol with a hydrocarbon coefficient ranging from 8.5 to 10.0 is produced.

Preferably, using the method according to the invention, a polyether polyol containing between 75 and 90 mole % of primary hydroxyl groups relative to all hydroxyl groups is produced.

Another object of the invention is the use of the polyether polyol as defined above, or the polyether polyol produced by the method defined above, for the production of flexible polyurethane foams, preferably highly resilient polyurethane foams.

Furthermore, an object of the invention is a flexible polyurethane foam produced by reacting an isocyanate and the polyether polyol as defined above or the polyether polyol produced by the method as defined above.

Preferably, the density of the flexible polyurethane foam ranges from 23 to 60 kg/m³, the hardness ranges from 1 to 6 kPa and the resilience is higher than 45%.

The production method according to the invention, which uses a DMC catalyst, makes it possible to obtain polyether polyols characterised by a high content of primary hydroxyl groups (75-100%) and a high hydrocarbon coefficient (at least 8.5). This makes them particularly suitable for the production of flexible polyurethane foams, especially highly resilient ones. In short, the method consists in dosing a mixture of ethylene oxide and C3-C8 epoxide with variable composition into the mixture of the starter and the active DMC catalyst. The variability in the composition of the mixture of ethylene oxide and C3-C8 epoxide consists in gradually increasing the proportion of ethylene oxide in the mixture. The high hydrocarbon coefficient of the polyol is achieved by using the starter and/or C3-C8 epoxide with high hydrocarbon coefficients. On the other hand, a high content of primary hydroxyl groups is achieved by using, at the end of dosing, a mixture of C3-C8 epoxide and ethylene oxide with a high content of ethylene oxide. By gradually increasing the proportion of ethylene oxide in the mixture, the formation of a two-phase system containing poly (ethylene oxide) is eliminated and, by using chemical structures with high hydrocarbon coefficients, the decrease in the hydrocarbon coefficient of the polyol resulting from the presence of oxyethylene groups is balanced.

Furthermore, the method according to the invention eliminates the disadvantages of producing polyols using the KOH catalyst method (production of unsaturated compounds, need for purification) and the DMC catalyst method (excessive hydrophilicity of polyols resulting from gradual chain termination with ethylene oxide without the use of chemical structures with high hydrocarbon coefficients).

The terms used in the description and in the patent claims have meanings commonly known and used by those skilled in the field to which the present invention belongs. For the sake of clarification, however, the following terms should be understood as follows.

Highly resilient flexible polyurethane foam refers to foam with a higher resilience than standard polyurethane foam of the same density, for example, for a density of 25 kg/m³ the resilience of highly resilient foam should be at least 45% and for a density of 35 kg/m³ at least 52%.

C3-C8 epoxide refers to the compound represented by the following general structural formula:

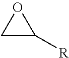

where R is an alkyl group, an aryl group, or a cycloalkyl group, the total number of carbon atoms in these groups being between 1 and 6, so that the epoxide molecule contains between 3 and 8 carbon atoms; The cycloalkyl group can have two carbon atoms in common with the carbon atoms of the oxirane ring. Examples of C3-C8 epoxy include propylene oxide, 1,2-butylene oxide, 1,2-epoxypentane, 1,2-epoxyhexane, 1,2-epoxyoctane, epoxycyclohexane or styrene oxide.

A detailed description of the invention and illustrative examples are given below.

As already mentioned above, polyether polyols obtained by the method according to the invention are characterised by a high content of primary hydroxyl groups, namely in the range of 75 to 100 mole %, preferably 75 to 90 mole % in relation to all hydroxyl groups. This is achieved by introducing oxyethylene groups into polyols. For this purpose, it is necessary to dose a mixture of C3-C8 epoxide and ethylene oxide with a high ethylene oxide content at the end of the oxyalkylation reaction. However, this procedure in general results in a decrease in the hydrocarbon coefficient of the polyether polyol produced, due to an increase in the total amount of oxyethylene groups in the polyol molecule characterised by a low hydrocarbon coefficient (w_{w}=6.0). As indicated above, polyether polyols with hydrocarbon ratios that are too low, in particular below 8.5, are characterised by excessive hydrophilicity, which results in poorer properties of polyurethane foams produced using them. In particular, due to the excessive hydrophilicity of the polyol, the water absorption increases and the hardness of the foams decreases. The polyol itself has a tendency to solidify, which, together with increased reactivity, contributes to difficult processing during foaming. Therefore, in order to counteract excessive hydrophilicity, it is necessary to introduce fragments of chemical structures with high hydrocarbon coefficients into the polyether polyol molecule. Due to the technology used to produce polyether polyols, there are two main possibilities for introducing this type of structure: via the starter, or to the oxyalkylene chain in the form of C3-C8 epoxides. The hydrocarbon coefficient of the polyol is the resulting weighted average of the hydrocarbon coefficients of the individual chemical structures of the polyol. In particular, during production, the hydrocarbon coefficient of the polyether polyol should be sought to be at least 8.5, preferably in the range of 8.5 to 10.0. Consequently, in order to compensate for the decrease in the coefficient due to the presence of oxyethylene groups, at least one component among the starter and the C3-C8 epoxide must have a high hydrocarbon coefficient (i.e. at least 9.5).

The table below may be helpful in selecting suitable starters and epoxides in the method of producing polyether polyols according to the invention, but is not limiting.

Comparison of hydrocarbon coefficients (w_{w}) of example molecules (starters and epoxides) forming chemical structures in the polyol molecule:

| | | a | b | d | |
|---|---|---|---|---|---|
| | | (amount | (amount | (amount | |
| Molecule | Character | of C) | of H) | of O) | w_{w} |
| Ethylene oxide | Epoxide | 2 | 4 | 1 | 6.0 |
| Propylene oxide | Epoxide | 3 | 6 | 1 | 9.0 |
| 1,2-butylene oxide | Epoxide | 4 | 8 | 1 | 12.0 |
| Styrene oxide | Epoxide | 8 | 8 | 1 | 20.0 |
| Epoxypentane | Epoxide | 5 | 10 | 1 | 15.0 |
| Epoxyhexane | Epoxide | 6 | 12 | 1 | 18.0 |
| Epoxycyclohexane | Epoxide | 6 | 10 | 1 | 17.0 |
| Epoxyoctane | Epoxide | 8 | 16 | 1 | 24.0 |
| Glycerol | Starter | 3 | 8 | 3 | 3.3 |
| Pentaerythritol | Starter | 5 | 12 | 4 | 4.0 |
| Sorbitol | Starter | 6 | 14 | 6 | 3.2 |
| Saccharose | Starter | 12 | 22 | 11 | 3.2 |
| Starch | Starter | (6)ₙ | (10)ₙ | (5)ₙ | 3.4 |
| Propylene glycol | Starter | 3 | 8 | 2 | 5.0 |
| Castor oil | Starter | 57 | 104 | 9 | 18.4 |
| MPG modified vegetable oil | Starter | approx. 57 | approx. 114 | approx. 11 | approx. 15.0 |
| DEG modified vegetable oil | Starter | approx. 60 | approx. 120 | approx. 14 | approx. 12.5 |
| Bisphenol A | Starter | 15 | 16 | 2 | 19.0 |
| Adipostatin A/Cardol | Starter | 21 | 36 | 2 | 30.0 |
| Prostacyclin | Starter | 20 | 32 | 5 | 11.2 |
| Lauryl alcohol | Starter | 12 | 26 | 1 | 37.0 |
| Cetyl alcohol | Starter | 16 | 34 | 1 | 49.0 |
| Stearyl alcohol | Starter | 18 | 38 | 1 | 55.0 |

In the context of the present invention, the starter may be a single chemical compound or a mixture of chemical compounds that contain hydroxyl groups. Due to its use in the production of highly resilient polyurethane foams, the starter should contain on average between 2.5 and 8 hydroxyl groups per molecule. As a result, the functionality of the resulting polyol is also in the range of 2.5 to 8, ensuring adequate cross-linking in the foam production process. Due to the use of the DMC catalyst, it is preferable that the average equivalent weight of the starter chain per hydroxyl group is at least 170. Otherwise, the DMC catalyst, which is sensitive to too high a content of hydroxyl groups, may be poisoned. From a technological point of view, on the other hand, it is preferable that the average equivalent chain weight per hydroxyl group of the starter is no more than 500. Otherwise, the build ratio in the reactor (the ratio of product weight to initial charge weight) may prove to be too small to carry out the process economically. In addition to the compromised economics of the process, the low build ratio is associated with a significant dilution of the catalyst in the starter, which in turn has a negative impact on the catalyst activation step. As mentioned above, preferable starters that increase the hydrocarbon coefficient of the polyol have a high hydrocarbon coefficient of at least 9.5. In terms of chemical structure, hydrophobic structures such as, for example, vegetable oils and modified vegetable oils are preferable. Vegetable oils are preferable to animal oils because of their high content of double bonds, which can be converted to hydroxyl groups through chemical treatment. An exemplary way to treat vegetable oil is to epoxidise the double bonds and then open the ring of the epoxide by means of a short diol.

A particularly favourable starter is castor oil, which, due to the presence of ricinoleic acid groups, contains hydroxyl groups in its structure and can therefore be used as a starter without additional chemical treatment leading to the formation of these groups. Castor oil is also preferable due to its good availability on the market. However, other compounds with suitable parameters, i.e. with a hydroxyl group content of 2.5 to 8 per molecule, an average equivalent chain weight of the starter per hydroxyl group in the range of 170 to 500 and a hydrocarbon coefficient of at least 9.5, are also used as starters. However, in the case of using a C3-C8 epoxide or a mixture of C3-C8 epoxides with a hydrocarbon coefficient of at least 9.5, any starter or starter mixture with a hydrocarbon coefficient of at least 9.5 or less may be used. The selection of a suitable starter lies within the skills of the specialist in the field to which the invention belongs.

Organic oxides, otherwise known as epoxides, are used as the main building unit of the polyether polyol chain in the method according to the invention. It is important from the point of view of obtaining a high content of primary hydroxyl groups to use the simplest epoxide, i.e. ethylene oxide, as oxyethylene groups are formed along with it. In addition to ethylene oxide, at least one epoxide with a higher content of carbon atoms per molecule should be used, preferably in the range of 3 to 8. When using a starter or starter mixture with a hydrocarbon coefficient of at least 9.5, any C3-C8 epoxide or mixture of C3-C8 epoxides may be used, whereas when the hydrocarbon coefficient of the starter or starter mixture is lower than 9.5, a C3-C8 epoxide or mixture of C3-C8 epoxides with a hydrocarbon coefficient of at least 9.5 must be used. Examples of epoxides with a hydrocarbon coefficient of at least 9.5 include 1,2-butylene oxide, 1,2-epoxypentane, 1,2-epoxyhexane, 1,2-epoxyoctane, epoxycyclohexane or styrene oxide. The selection of a suitable epoxide, or proportion of a mixture of epoxides, lies within the skill of one skilled in the art to which this invention belongs.

Furthermore, it should be noted that when determining the hydrocarbon coefficient of mixtures, the weighted average of the hydrocarbon coefficients of individual components is taken into account.

The simplest, and most economically preferable, C3-C8 epoxide is propylene oxide. However, due to its lowest hydrocarbon coefficient among C3-C8 epoxides, equal to 9.0, its use is limited to use in combination with a starter with a hydrocarbon coefficient of at least 9.5, or in a mixture with a second C3-C8 epoxide with a hydrocarbon coefficient of at least 9.5, preferably styrene oxide or 1,2-butylene oxide.

From an economic point of view and due to market availability, it is also preferable to use 1,2-butylene oxide alone or styrene oxide alone.

In summary, one of the following three strategies is followed to achieve a high hydrocarbon coefficient of the polyol:
1. Use of a starter with a hydrocarbon coefficient of at least 9.5 or a mixture of starters with a weighted average of hydrocarbon coefficients of at least 9.5.
2. Use of a C3-C8 epoxide with a hydrocarbon coefficient of at least 9.5 or a mixture of C3-C8 epoxides with a weighted average of hydrocarbon coefficients of at least 9.5.
3. Use of both a starter and a C3-C8 epioxide with hydrocarbon coefficients of at least 9.5 or suitable mixtures of starters or C3-C8 epoxides with weighted averages of hydrocarbon coefficients of at least 9.5;
wherein the hydrocarbon coefficients of the C3-C8 epoxide and the starter, represented by the general formula CₐH_{b}O_{d}, are calculated according to the formula

$${w}_{W} = \frac{4 a + b}{2 d}$$

where:
a is the number of carbon atoms in the molecule of C3-C8 epoxide or starter,
b is the number of hydrogen atoms in the molecule of C3-C8 epoxide or starter,
d is the number of oxygen atoms in the molecule of C3-C8 epoxide or starter.

Therefore, by using suitable reagents in the method according to the invention, a polyol of suitable composition is obtained, so that the hydrocarbon coefficient of the polyol is in the desired range.

Having prepared an initial charge containing a suitable starter (selected according to the above guidelines) and a DMC catalyst, the traces of water present in the starter should be removed using any drying method. In practice, most often for this purpose, the preliminary feed is heated to a temperature in the range of 100 °C to 150 °C and a barbotage of nitrogen or other inert gas is carried out at atmospheric pressure or under reduced pressure. The heating process can optionally be carried out simultaneously with inert gas barbotage. Regardless of the drying method used, the water content of the initial charge should be as low as possible, preferably below 0.1% by weight, before proceeding to the catalyst activation step.

Before the main step, i.e. oxyalkylation, catalyst activation is required. Activation is the process of dosing a small amount of C3-C8 epoxide or a mixture of C3-C8 epoxide with ethylene oxide (usually propylene oxide or a mixture of propylene oxide with ethylene oxide) into the preliminary feed and leaving the mixture (preferably at a temperature of 100 °C to 150 °C) until symptoms of the reaction of the epoxide with the starter appear in the form of exotherm and pressure drop in the reactor. In practice, in the catalyst activation step, the epoxide is dosed in one or more portions, each time waiting for the symptoms mentioned. The amounts of epoxide used are generally in the range of 2% to 20% by weight of the preliminary feed. Amounts below 2% are too small for activation, while amounts above 20% can cause excessive exotherm during activation.

After the catalyst activation step, the main oxyalkylation step is carried out. In the known methods that use a DMC catalyst, it is not possible to directly terminate the chain with oxyethylene groups. Direct termination should be understood as a stepwise, rapid increase in the proportion of ethylene oxide in the dosed oxide mixture. Direct termination is commonly used with a KOH catalyst. Dosing a mixture of C3-C8 epoxide and ethylene oxide with a high content of ethylene oxide into a reaction system with a DMC catalyst containing a polyether polyol rich in C3-C8 epoxide results in the formation of a two-phase system containing the original polyether polyol and poly(ethylene oxide). In order to prevent this adverse phenomenon, the method according to the invention uses a dosing system in which the composition of the dosed mixture is changed over the course of dosing in such a way that the proportion of ethylene oxide in the dosed mixture is gradually increased. The initial composition of the mixture is characterised by a low content of ethylene oxide, i.e. in the range of 5% to 15% by weight, preferably 10% by weight. In contrast, the final composition of the mixture is characterised by a high content of ethylene oxide, i.e. in the range of 70% to 100% by weight, preferably in the range of 90% to 100% by weight, and most preferably 100% by weight (pure ethylene oxide). The proportion of ethylene oxide in the mixture varies in either a stepwise or continuous manner. In the case of stepwise dosing, there is at least one transition step between the initial and final steps with the proportion of ethylene oxide in the mixture being between the above ranges, i.e. between 15% and 70% by weight.

The temperature of the oxyalkylation reaction in the presence of a DMC catalyst should be kept constant throughout the epoxide dosage process and during annealing. In the method according to the invention, a temperature range of 100 °C to 150 °C is used. Below 100 °C, DMC catalysts show reduced activity, i.e. the oxyalkylation reaction proceeds more slowly and it happens that the catalyst tends to deactivate, whereas above 150 °C. DMC catalysts start to decompose. The most preferable reaction temperatures are in the range of 120 °C to 140 °C, due to the fact that there are no significant differences in the course of the reaction depending on temperature in this range.

Finally, annealing of the resulting polyol at the reaction temperature (i.e. 100 °C to 150 °C) until constant pressure is achieved is carried out and the volatile organic compounds are removed by any known means, e.g. by degassing with barbotage of nitrogen or other inert gas under reduced pressure or at atmospheric pressure, degassing under reduced pressure or on an evaporator, etc.

The catalyst activation, oxyalkylation and annealing steps are usually carried out at the same temperature. In addition, the same or different C3-C8 epoxides are used in the catalyst activation and oxyalkylation steps.

Using the method according to the invention, polyether polyols with a number average molecular weight in the range of 1000 g/mol to 50000 g/mol, preferably 4000 to 12000 g/mol and most preferably 4000 to 6000 g/mol are obtained.

The invention is illustrated by means of the following examples, which, however, do not constitute a limitation to the invention. The following materials were used in the examples:

Starter 1: castor oil, commercially available and obtained from PPH Standard. It is a triglyceride of fatty acids of plant origin, mainly ricinoleic acid, containing on average about 2.7 hydroxyl groups per molecule and with an equivalent weight per hydroxyl group of about 340.

Starter 2: sorbitol-based polyoxypropylenehexol (contains nominally 6 hydroxyl groups per molecule) with an equivalent weight per hydroxyl group of approximately 330, commercially available under the name Rokopol RF2000, obtained from PCC Rokita SA.

Starter 3: glycerine-based polyoxypropylenetriol (contains nominally 3 hydroxyl groups per molecule) with an equivalent weight per hydroxyl group of approximately 190, commercially available under the name Rokopol G500, obtained from PCC Rokita SA.

MEO-DMC catalyst: a double metal cyanide (DMC) catalyst, produced by reacting an aqueous metal salt solution with an aqueous metal cyanide salt solution in the presence of two organic complexing ligands, commercially available and obtained from Mexeo.

Propylene oxide: 1,2-epoxypropane with a purity of at least 99.97% (GC), commercially available and obtained from PCC Rokita SA.

Ethylene oxide: oxirane with a purity of at least. 99.9%, commercially available and obtained from Orlen.

Styrene oxide: phenyloxirane of technical purity, commercially available and obtained from Biesterfeld.

Rokopol iPol H: a polymeric polyol, a dispersion of a polymer in a reactive polyether polyol, with a hydroxyl value in the range 49-56, commercially available and obtained from PCC Rokita SA.

TDI 80: a mixture comprising 80% of 2,4-diisocyanatoluene and 20% of 2,6-diisocyanatoluene, commercially available and obtained from Borsodchem.

Niax A-33 foam additive: commercially available raw material, obtained from Momentive. It is an aliphatic amine that is a catalyst for reacting isocyanates with alcohols, including polyols, and with water.

Tegostab B8783LF2 foam additive: commercially available raw material, obtained from Evonik. Chemically, it is a silicone surfactant that allows emulsification of a mixture of polyols and isocyanate.

Foam additives 90% diethanolamine and Ortegol 204: commercially available raw materials, obtained from Evonik. Chemically, these are mixtures containing aliphatic amines. They serve as crosslinking additives in the polymerisation process.

Kosmos 29: stannous octoate, a commercial raw material, available and obtained from Evonik. It is a metal-organic catalyst for reacting isocyanates with alcohols, including polyols.

All of the above materials were used in an accessible form, without additional preparation.

The molecular weight was determined by calculation, taking into account the determined hydroxyl value (determined according to ASTM D4274-16 method D) and the gel permeation chromatography (GPC) elugram.

The ethylene oxide content was determined based on the 1H NMR spectrum according to ASTM D4875-18 method A, or calculated from the weight balance of the raw materials used in the synthesis.

The hydrocarbon ratios of the raw materials and the produced polyols, which can be represented by the general formula CₐH_{b}O_{d}, were calculated based on the formula given in this specification, namely:

$${w}_{W} = \frac{4 a + b}{2 d}$$

The method of calculation is presented in more detail in the state of the art description.

The density of the foams was determined according to method ISO 845.

The rise time and settling of the foams were determined with a Foamat foaming attachment. The hardness of the foams was determined using the Zwick/Roel Z010 device according to ISO 3386-1.

The resilience of the foams was determined using the Ball Rebound method, according to ISO 8307.

### EXAMPLE W1 OF THE SYNTHESIS ACCORDING TO THE INVENTION

Into a steel pressure reactor, equipped with a mechanical stirrer and temperature control, 1000 g of Starter 1, and 0.23 g of MEO-DMC catalyst were fed. The initial charge was heated to a temperature of 135 °C and dehydrated under vacuum with nitrogen barbotage for 60 minutes. Activation of the catalyst was performed by dosing 100 g of a mixture containing 90% of propylene oxide and 10% of ethylene oxide and annealing at a temperature of 135 °C for 40 minutes, after which there was a pronounced drop in pressure and exotherm indicating that the reaction had occurred. Then, 2000 g of a mixture containing 90% of propylene oxide and 10% of ethylene oxide was dosed at such a rate that the pressure in the reactor did not exceed 0.4 MPa, maintaining a temperature of 135 °C by means of a temperature control system. Then, 400 g of a mixture containing 50% of propylene oxide and 50% of ethylene oxide was dosed under the same process parameters. Then, 600 g of a mixture containing 30% of propylene oxide and 70% of ethylene oxide was dosed under the same process parameters. Then, 600 g of ethylene oxide was dosed under the same process parameters. The product was annealed at a temperature of 135 °C for 30 minutes until a constant pressure was achieved, after which the volatile organic compounds were removed using nitrogen barbotage under vacuum.

A polyether polyol was obtained in the form of a homogeneous liquid characterised by a content of primary hydroxyl groups of 85%, a hydrocarbon coefficient of 8.9, a hydroxyl value of 35.9, a molecular weight of approximately 4220, a dynamic viscosity at a temperature of 25 °C of 641 and a total ethylene oxide content of 30.9%.

### EXAMPLE W2 OF THE SYNTHESIS ACCORDING TO THE INVENTION

Into a steel pressure reactor, equipped with a mechanical stirrer and temperature control, 800 g of Starter 1, and 200 g of Starter 2, and 0.23 g of MEO-DMC catalyst were fed. The initial charge was heated to a temperature of 135 °C and dehydrated under vacuum with nitrogen barbotage for 60 minutes. Activation of the catalyst was performed by dosing 100 g of a mixture containing 90% of propylene oxide and 10% of ethylene oxide and annealing at a temperature of 135 °C for 40 minutes, after which there was a pronounced drop in pressure and exotherm indicating that the reaction had occurred. Then, 1900 g of a mixture containing 90% of propylene oxide and 10% of ethylene oxide was dosed at such a rate that the pressure in the reactor did not exceed 0.4 MPa, maintaining a temperature of 135 °C by means of a temperature control system. Then, 400 g of a mixture containing 50% of propylene oxide and 50% of ethylene oxide was dosed under the same process parameters. Then, 400 g of a mixture containing 30% of propylene oxide and 70% of ethylene oxide was dosed under the same process parameters. Then, 600 g of a mixture containing 10% of propylene oxide and 90% of ethylene oxide was dosed under the same process parameters. Then, 50 g of ethylene oxide was dosed under the same process parameters. The product was annealed at a temperature of 135 °C for 30 minutes until a constant pressure was achieved, after which the volatile organic compounds were removed using nitrogen barbotage under vacuum.

A polyether polyol was obtained in the form of a homogeneous liquid with a tendency to solidify at lower temperatures, characterised by a content of primary hydroxyl groups of 77%, a hydrocarbon coefficient of 8.5, a hydroxyl value of 36.0, a molecular weight of approximately 5240, a dynamic viscosity at a temperature of 25 °C of 606 and a total ethylene oxide content of 28.5%.

### EXAMPLE W3 OF THE SYNTHESIS ACCORDING TO THE INVENTION

Into a steel pressure reactor, equipped with a mechanical stirrer and temperature control, 1000 g of Starter 1, and 0.23 g of MEO-DMC catalyst were fed. The initial charge was heated to a temperature of 135 °C and dehydrated under vacuum with nitrogen barbotage for 60 minutes. Activation of the catalyst was performed by dosing 100 g of a mixture containing 90% of propylene oxide and 10% of ethylene oxide and annealing at a temperature of 135 °C for 40 minutes, after which there was a pronounced drop in pressure and exotherm indicating that the reaction had occurred. Then, 1900 g of a mixture containing 90% of propylene oxide and 10% of ethylene oxide was dosed at such a rate that the pressure in the reactor did not exceed 0.4 MPa, maintaining a temperature of 135 °C by means of a temperature control system. Then, the ratio of ethylene oxide to propylene oxide was changed continuously, dosing a total of 620 g of ethylene oxide and 380 g of propylene oxide under the same process parameters. Then, 600 g of ethylene oxide was dosed under the same process parameters. The product was annealed at a temperature of 135 °C for 30 minutes until a constant pressure was achieved, after which the volatile organic compounds were removed using nitrogen barbotage under vacuum.

A polyether polyol was obtained in the form of a homogeneous liquid, which partially solidified after a few days, characterised by a content of primary hydroxyl groups of 85%, a hydrocarbon coefficient of 8.9, a hydroxyl value of 35.9, a molecular weight of approximately 4220, a dynamic viscosity at a temperature of 25 °C of 641 and a total ethylene oxide content of 30.9%.

### EXAMPLE W4 OF THE SYNTHESIS ACCORDING TO THE INVENTION

Into a steel pressure reactor, equipped with a mechanical stirrer and temperature control, 500 g of Starter 3, and 0.46 g of MEO-DMC catalyst were fed. The initial charge was heated to a temperature of 140 °C and dehydrated under vacuum with nitrogen barbotage for 30 minutes. Activation of the catalyst was performed by dosing 40 g of propylene oxide and annealing at a temperature of 140 °C for 30 minutes, after which there was a pronounced drop in pressure and exotherm indicating that the reaction had occurred. Then, 2400 g of a mixture containing 45% of styrene oxide, 45% of propylene oxide and 10% of ethylene oxide was dosed at such a rate that the pressure in the reactor did not exceed 0.6 MPa, maintaining a temperature of 140 °C by means of a temperature control system. Then, 300 g of a mixture containing 25% of styrene oxide, 25% of propylene oxide and 50% of ethylene oxide was dosed under the same process parameters. Then, 400 g of a mixture containing 15% of styrene oxide, 15% of propylene oxide and 70% of ethylene oxide was dosed under the same process parameters. Then, 700 g of a mixture containing 5% of styrene oxide, 5% of propylene oxide and 90% of ethylene oxide was dosed under the same process parameters. The product was annealed at a temperature of 140 °C for 30 minutes until a constant pressure was achieved, after which the volatile organic compounds were removed using nitrogen barbotage under vacuum.

A polyether polyol was obtained in the form of a very viscous liquid, characterised by a content of primary hydroxyl groups of 75%, a hydrocarbon coefficient of 9.1, a hydroxyl value of 35, a molecular weight of approximately 4810, a dynamic viscosity at a temperature of 25 °C of 7420 and a total ethylene oxide content of 30.0%.

### EXAMPLE W5 OF THE SYNTHESIS ACCORDING TO THE INVENTION

Into a steel pressure reactor, equipped with a mechanical stirrer and temperature control, 500 g of Starter 3, and 0.46 g of MEO-DMC catalyst were fed. The initial charge was heated to a temperature of 140 °C and dehydrated under vacuum with nitrogen barbotage for 30 minutes. Activation of the catalyst was performed by dosing in two portions 40 g of 1,2-butylene oxide and annealing at a temperature of 140 °C after each portion for 20 minutes, after which there was a pronounced drop in pressure and exothermia indicating that the reaction had occurred. Then, 2400 g of a mixture containing 90% of 1,2-butylene oxide and 10% of ethylene oxide was dosed at such a rate that the pressure in the reactor did not exceed 0.4 MPa, maintaining a temperature of 140 °C by means of a temperature control system. Then, 300 g of a mixture containing 50% of 1,2-butylene oxide and 50% of ethylene oxide was dosed under the same process parameters. Then, 400 g of a mixture containing 30% of 1,2-butylene oxide and 70% of ethylene oxide was dosed under the same process parameters. Then, 700 g of a mixture containing 10% of 1,2-butylene oxide and 90% of ethylene oxide was dosed under the same process parameters. The product was annealed at a temperature of 140 °C for 30 minutes until a constant pressure was achieved, after which the volatile organic compounds were removed using nitrogen barbotage under vacuum.

A polyether polyol was obtained in the form of a homogeneous liquid characterised by a content of primary hydroxyl groups of 86%, a hydrocarbon coefficient of 9.0, a hydroxyl value of 35, a molecular weight of approximately 4810, a dynamic viscosity at a temperature of 25 °C of 1410 and a total ethylene oxide content of 30.2%.

### EXAMPLE W6 OF THE USE OF POLYETHER POLYOL FOR THE PRODUCTION OF HIGHLY RESILIENT POLYURETHANE FOAM

A mixture containing 25 parts of polyether polyol obtained according to Example W1, 75 parts of Rokopol iPol H, 2.60 parts of water, 0.09 parts of Niax A-33 catalyst, 0.25 parts of Tegostab B8783LF surfactant, 1.05 parts of 90% diethanolamine, 1.2 parts of Ortegol 204 cross-linking additive, 0.12 parts of Kosmos 29 catalyst, and 38.2 parts of TDI 80 (a mixture of 80% of 2,4-diisocyanatotoluene and 20% of 2,6-diisocyanatotoluene) was poured into an open mould with a base of 20×20 cm. The formulation index was 104.

A free-rising foam with the following properties was obtained: density of 35.0 kg/m³, rise time of 138 seconds, relapse of 0.3%, hardness CV40 of 3.9 kPa and resilience of 54%.

1. A polyether polyol containing 75 to 100 mole % of primary hydroxyl groups relative to all hydroxyl groups and having a hydrocarbon coefficient (w_{w}) of at least 8.5, the hydrocarbon coefficient being calculated according to the formula:
$${w}_{W} = \frac{4 a + b}{2 d}$$
where:
a is the number of carbon atoms in the polyether polyol molecule, which is the sum of the numbers of carbon atoms originating from the starter, ethylene oxide and C3-C8 epoxide used to produce the said polyol;
b is the number of hydrogen atoms in the polyether polyol molecule, which is the sum of the numbers of hydrogen atoms originating from the starter, ethylene oxide and C3-C8 epoxide used to produce the said polyol;
d is the number of oxygen atoms in the polyether polyol molecule, which is the sum of the numbers of oxygen atoms originating from the starter, ethylene oxide and C3-C8 epoxide used to produce the said polyol.

2. The polyether polyol according to claim 1, characterised in that its hydrocarbon coefficient (w_{w}) ranges from 8.5 to 10.0.

3. The polyether polyol according to claim 1 [or 2], characterised in that it contains between 75 and 90 mole % of primary hydroxyl groups relative to all hydroxyl groups.

4. A method of producing a polyether polyol containing 75 to 100 mole % of primary hydroxyl groups relative to all hydroxyl groups and having a hydrocarbon coefficient (w_{w}) of at least 8.5, characterised in that it includes the following steps:
a) preparing an initial charge containing:
a starter or a mixture of starters containing hydroxyl groups, and
double metal cyanide (DMC) catalyst;
b) drying the initial charge;
c) dosing C3-C8 epoxide or a mixture of C3-C8 epoxide with ethylene oxide into the initial charge and leaving the mixture until the reaction exotherms in order to activate the DMC catalyst;
d) dosing, to the mixture obtained in step c), a mixture containing ethylene oxide and C3-C8 epoxide or a mixture of C3-C8 epoxides in which the weight proportions of ethylene oxide and C3-C8 epoxide or of the mixture of C3-C8 epoxides are changed in a stepwise or continuous manner in order to oxyalkylate the starter against the activated DMC catalyst, with the initial proportion of ethylene oxide in the dosed mixture ranging from 5 to 15% by weight and the final proportion ranging from 70 to 100% by weight, and the temperature of the resulting mixture being maintained between 100 °C and 150 °C; and
e) annealing the polyether polyol at a temperature ranging from 100 °C to 150 °C until constant pressure is obtained and removing volatile compounds;
wherein in the method C3-C8 epoxide is used represented by a general structural formula: 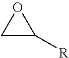
where R is an alkyl group, an aryl group, or a cycloalkyl group, the total number of carbon atoms in these groups being between 1 and 6, so that the molecule of this epoxide contains between 3 and 8 carbon atoms;
wherein the same or different C3-C8 epoxides are used in steps (c) and (d);
wherein in the method (i) a starter or a mixture of starters with a hydrocarbon coefficient of at least 9.5 or (ii) C3-C8 epoxide or a mixture of C3-C8 epoxides with a hydrocarbon coefficient of at least 9.5 or (iii) a starter or a mixture of starters and C3-C8 epoxide or a mixture of C3-C8 epoxides with hydrocarbon coefficients of at least 9.5 are used;
wherein in the case of using a mixture of starters or C3-C8 epoxides, the weighted average of the hydrocarbon coefficients of the individual components is taken into account;
wherein the hydrocarbon coefficients of the C3-C8 epoxide and the starter, represented by the general formula CₐH_{b}O_{d}, are calculated according to the formula
$${w}_{W} = \frac{4 a + b}{2 d}$$
where:
a is the number of carbon atoms in the molecule of C3-C8 epoxide or starter,
b is the number of hydrogen atoms in the molecule of C3-C8 epoxide or starter,
d is the number of oxygen atoms in the molecule of C3-C8 epoxide or starter.

5. The method of producing a polyether polyol according to claim 4, characterised in that a compound containing an average of 2.5 to 8 hydroxyl groups per molecule and with an average equivalent chain weight per hydroxyl group of 170 to 500 is used as the starter.

6. The method of producing a polyether polyol according to claim 5, characterised in that a vegetable oil or a modified vegetable oil is used as the starter.

7. The method of producing a polyether polyol according to claim 6, characterised in that castor oil is used as the starter.

8. The method of producing a polyether polyol according to claim 4, characterised in that in step c), C3-C8 epoxide or a mixture of C3-C8 epoxide with ethylene oxide is used in an amount of 2% to 20% by weight relative to the amount of the preliminary feed, with C3-C8 epoxide or a mixture of C3-C8 epoxide with ethylene oxide being added in one or more portions.

9. The method of producing a polyether polyol according to claim 4, characterised in that in step d), propylene oxide, 1,2-butylene oxide, styrene oxide, 1,2-epoxypentane, 1,2-epoxyhexane, epoxycyclohexane or 1,2-epoxyoctane or a mixture thereof is used as the C3-C8 epoxide or the mixture of C3-C8 epoxides.

10. The method of producing a polyether polyol according to claim 9, characterised in that in step d), propylene oxide, styrene oxide, 1,2-butylene oxide or a mixture thereof is used as the C3-C8 epoxide or the mixture of C3-C8 epoxides.

11. The method of producing a polyether polyol according to claim 4, characterised in that a mixture in which the weight proportion of ethylene oxide is 100% is dosed at the end of step d).

12. The method of producing a polyether polyol according to claim 4, characterised in that the polyether polyol with a hydrocarbon coefficient ranging from 8.5 to 10.0 is produced.

13. The method of producing a polyether polyol according to claim 4, characterised in that the polyether polyol containing between 75 and 90 mole % of primary hydroxyl groups relative to all hydroxyl groups is produced.

14. A use of the polyether polyol as defined in claim 1 or the polyether polyol produced by the method, for the production of flexible polyurethane foams.

15. The use according to claim 14, characterised in that highly resilient polyurethane foams are produced.

16. A flexible polyurethane foam produced by reacting an isocyanate and a polyol, characterised in that the polyol is either the polyether polyol as defined in claim 1 or the polyether polyol produced.

17. The flexible polyurethane foam according to claim 16, characterised in that its density, determined according to method ISO 845, ranges from 23 to 60 kg/m³, the hardness, determined according to ISO 3386-1, ranges from 1 to 6 kPa and the resilience, determined according to ISO 8307, is higher than 45%.
